(19) United States
(12) Patent Application Publication
(10) Pub. No.: US 2009/0210239 A1
(43) Pub. Date: Aug. 20, 2009

(54) Method for Encoding and Decoding Object-Based Audio Signal and Apparatus Thereof

(75) Inventors: Sung Yong Yoon, Seoul (KR); Hee Suk Pang, Seoul (KR); Hyun Kook Lee, Kyunggi-do (KR); Dong Soo Kim, Seoul (KR); Jae Hyun Lim, Seoul (KR)

Correspondence Address: FISH & RICHARDSON P.C., PO BOX 1022, MINNEAPOLIS, MN, 55440-1022, US

(73) Assignee: LG ELECTRONICS INC., Seoul (KR)

(21) Appl. No.: 12/438,940

(22) PCT Filed: Nov. 24, 2007
(86) PCT No.: PCT/KR2007/005968

§ 371 Date: Feb. 25, 2009

Related U.S. Application Data
(60) Provisional application No. 60/860,823, filed on Nov. 24, 2006.
(60) Provisional application No. 60/901,642, filed on Feb. 16, 2007.
(60) Provisional application No. 60/981,517, filed on Oct. 22, 2007.
(60) Provisional application No. 60/982,408, filed on Oct. 24, 2007.

(51) Int. Cl. G10L 21/00

(52) U.S. Cl. 704/500

(57) ABSTRACT

The present invention relates to a method and apparatus for encoding and decoding object-based audio signals. This audio decoding method includes extracting a first audio signal and a first audio parameter in which a music object are encoded on a channel basis and a second audio signal and a second audio parameter in which a vocal object are encoded on an object basis, from an audio signal, generating a third audio signal by employing at least one of the first and second audio signals, and generating a multi-channel audio signal by employing at least one of the first and second audio parameters and the third audio signal. Accordingly, the amount of calculation in encoding and decoding processes and the size of a bitstream that is encoded can be reduced efficiently.

### TECHNICAL FIELD

The present invention relates to an audio encoding and decoding method and apparatus for encoding and decoding object-based audio signals so that the audio signals can be processed through grouping efficiently.

### BACKGROUND ART

In general, an object-based audio codec employs a method of sending the sum of a specific parameter extracted from each object signal and the object signals, restoring the respective object signals therefrom, and mixing the object signals as many as a desired number of channels. Thus, when the number of object signals is many, the amount of information necessary to mix respective object signals is increased in proportion to the number of the object signals.

However, in object signals having a close correlationship, similar mixing information, and so on are sent with respect to each object signal. Accordingly, if the object signals are bundled into one group and the same information is sent only once, efficiency can be improved.

Even in a general encoding and decoding method, a similar effect can be obtained by bundling several object signals into one object signal. However, if this method is used, the unit of the object signal is increased and it is also impossible to mix the object signal as an original object signal unit before bundling.

### DISCLOSURE OF INVENTION

### Technical Problem

Accordingly, an object of the present invention is to provide an audio encoding and decoding method for encoding and decoding object signals, in which object audio signals with an association are bundled into one group and can be thus processed on a per group basis, and an apparatus thereof.

### Technical Solution

To accomplish the above object, an audio signal decoding method according to the present invention includes the steps of extracting a first audio signal and a first audio parameter in which a music object are encoded on a channel basis and a second audio signal and a second audio parameter in which a vocal object are encoded on an object basis, from an audio signal; generating a third audio signal by employing at least one of the first and second audio signals, and generating a multi-channel audio signal by employing at least one of the first and second audio parameters and the third audio signal.

Further, to accomplish the above object, an audio decoding method according to the present invention includes the steps of receiving a down-mix signal, extracting a first audio signal in which a music object including a vocal object is encoded and a second audio signal in which a vocal object is encoded, from the down-mix signal, and generating any one of an audio signal including only the vocal object, an audio signal comprising the vocal object, and an audio signal not including the vocal object based on the first and second audio signals.

Meanwhile, an audio signal decoding apparatus according to the present invention includes a multiplexer for extracting a down-mix signal and side information from a received bitstream, an object decoder for generating a third audio signal by employing at least one of a first audio signal in which a music object extracted from the down-mix signal is encoded on a channel basis and a second audio signal in which a vocal object extracted from the down-mix signal is encoded on an object basis, and a multi-channel decoder for generating a multi-channel audio signal by employing at least one of a first audio parameter and a second audio parameter extracted from the side information, and the third audio signal.

Further, an audio decoding apparatus according to the present invention includes an object decoder for generating any one of an audio signal including only a vocal object, an audio signal comprising the vocal object, and an audio signal not including the vocal object based on a first audio signal in which a music object extracted from a down-mix signal is encoded and a second audio signal in which a vocal object extracted from the down-mix signal is encoded, and a multi-channel decoder for generating a multi-channel audio signal by employing a signal output from the object decoder.

Further, an audio encoding method according to the present invention includes the steps of generating a first audio signal in which a music object is encoded on a channel basis, and a first audio parameter corresponding to the music object, generating a second audio signal in which a vocal object is encoded on an object basis, and a second audio parameter corresponding to the vocal object, and generating a bitstream including the first and second audio signals, and the first and second audio parameters.

According to the present invention, there is provided an audio encoding apparatus including a multi-channel encoder for generating a first audio signal in which a music object is encoded on a channel basis, and a channel-based first audio parameter with respect to the music object, an object encoder for generating a second audio signal in which a vocal object is encoded on an object basis, and an object-based second audio parameter with respect to the vocal object, and a multiplexer for generating a bitstream including the first and second audio signals, and the first and second audio parameters.

To accomplish the above object, the present invention provides a computer-readable recording medium in which a program for executing the above method in a computer is recorded.

### ADVANTAGEOUS EFFECTS

According to the present invention, object audio signals with an association can be processed on a group basis while utilizing the advantages of encoding and decoding of object-based audio signals to the greatest extent possible. Accordingly, efficiency in terms of the amount of calculation in encoding and decoding processes, the size of a bit stream that is encoded, and so on can be improved. Further, the present invention can be applied to a karaoke system, etc. usefully by grouping object signals into a music object, a vocal object, etc.

### BRIEF DESCRIPTION OF THE DRAWINGS

FIG. 1 is a block diagram of an audio encoding and decoding apparatus according to a first embodiment of the present invention;

FIG. 2 is a block diagram of an audio encoding and decoding apparatus according to a second embodiment of the present invention;

FIG. 3 is a view illustrating a correlation between a sound source, groups, and object signals;

FIG. 4 is a block diagram of an audio encoding and decoding apparatus according to a third embodiment of the present invention;

FIGS. 5 and 6 are views illustrating a main object and a background object;

FIGS. 7 and 8 are views illustrating a configuration of a bit stream generated in the encoding apparatus;

FIG. 9 is a block diagram of an audio encoding and decoding apparatus according to a fourth embodiment of the present invention;

FIG. 10 is a view illustrating a case where a plurality of main objects are used;

FIG. 11 is a block diagram of an audio encoding and decoding apparatus according to a fifth embodiment of the present invention;

FIG. 12 is a block diagram of an audio encoding and decoding apparatus according to a sixth embodiment of the present invention;

FIG. 13 is a block diagram of an audio encoding and decoding apparatus according to a seventh embodiment of the present invention;

FIG. 14 is a block diagram of an audio encoding and decoding apparatus according to an eighth embodiment of the present invention;

FIG. 15 is a block diagram of an audio encoding and decoding apparatus according to a ninth embodiment of the present invention; and

FIG. 16 is a view illustrating case where vocal objects are encoded step by step.

### BEST MODE FOR CARRYING OUT THE INVENTION

The present invention will now be described in detail with reference to the accompanying drawings.

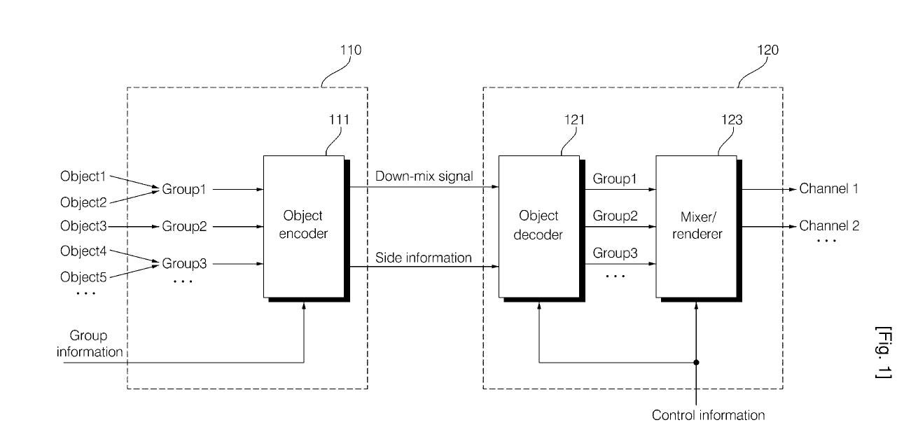

FIG. 1 is a block diagram of an audio encoding and decoding apparatus according to a first embodiment of the present invention. The audio encoding and decoding apparatus according to the present embodiment decodes and encodes an object signal corresponding to an object-based audio signal on the basis of a grouping concept. In other words, encoding and decoding processes are performed on a per group basis by binding one or more object signals with an association into the same group.

Referring to FIG. 1, there are shown an audio encoding apparatus 110 including an object encoder 111, and an audio decoding apparatus 120 including an object decoder 121 and a mixer/renderer 123. Though not shown in the drawing, the encoding apparatus 110 may include a multiplexer, etc. for generating a bitstream in which a down-mix signal and side information are combined, and the decoding apparatus 120 may include a demultiplexer, etc. for extracting a down-mix signal and side information from a received bitstream. This construction is the case with the encoding and the decoding apparatus according to other embodiments that are described later on.

The encoding apparatus 110 receives N object signals, and group information including relative position information, size information, time lag information, etc. on a per group basis, of object signal with an association. The encoding apparatus 110 encodes a signal in which object signals with an association are grouped, and generates an object-based down-mix signal having one or more channels and side information, including information extracted from each object signal, etc.

In the decoding apparatus 120, the object decoder 121 generates signals, which are encoded on the basis of grouping, based on the down-mix signal and the side information, and the mixer/renderer 123 places the signals output from the object decoder 121 at specific positions on a multi-channel space at a specific level based on control information. That is, the decoding apparatus 120 generates multi-channel signals without unpacking signals, which are encoded on the basis of grouping, on a per object basis.

Through this construction, the amount of information to be transmitted can be reduced by grouping and encoding object signals having similar position change, size change, delay change, etc. according to time. Further, if object signals are grouped, common side information with respect to one group can be transmitted, so several object signals belonging to the same group can be controlled easily.

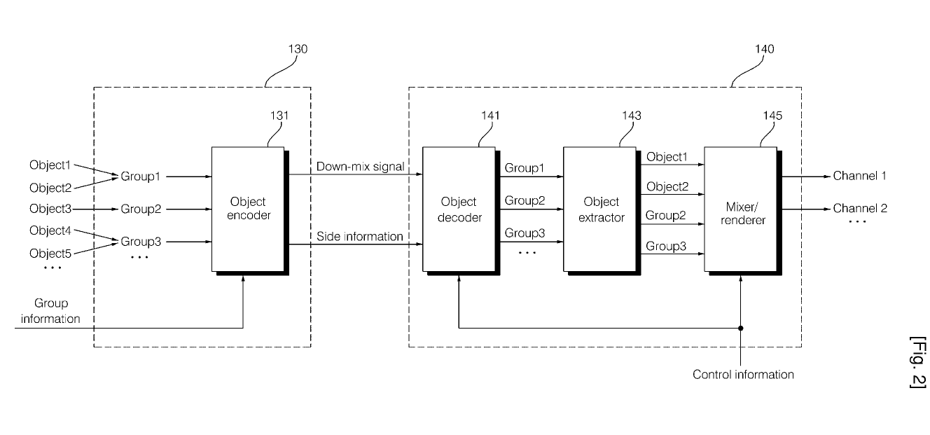

FIG. 2 is a block diagram of an audio encoding and decoding apparatus according to a second embodiment of the present invention. An audio signal decoding apparatus 140 according to the present embodiment is different from the first embodiment in that it further includes an object extractor 143.

In other words, the encoding apparatus 130, the object decoder 141, and the mixer/renderer 145 have the same function and construction as those of the first embodiment. However, since the decoding apparatus 140 further includes the object extractor 143, a group to which a corresponding object signal belongs can be unpacked on a per object basis when the unpacking of an object unit is necessary. In this case, the entire groups are not unpacked on a per object basis, but object signals can be extracted with respect to only groups on which mixing every group, etc. cannot be performed.

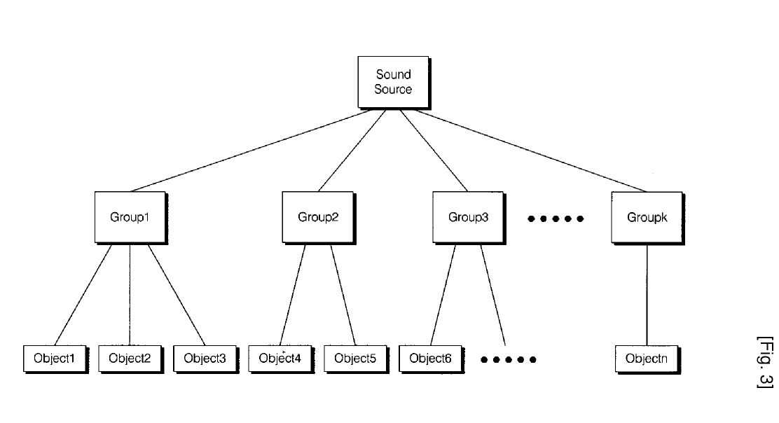

FIG. 3 is a view illustrating a correlation between a sound source, groups, and object signals. As shown in FIG. 3, object signals having a similar property are grouped so that the size of a bitstream can be reduced and the entire object signals belongs to an upper group.

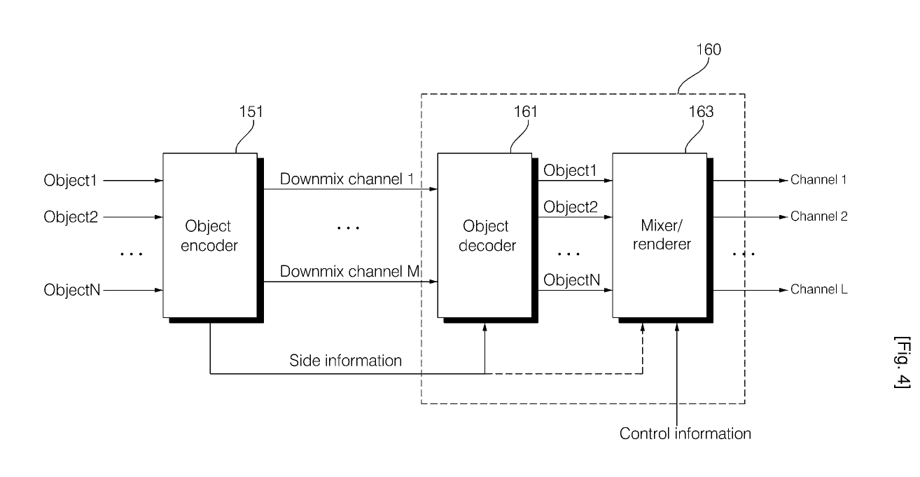

FIG. 4 is a block diagram of an audio encoding and decoding apparatus according to a third embodiment of the present invention. In the audio encoding and decoding apparatus according to the present embodiment, the concept of a core down-mix channel is used.

Referring to FIG. 4, there are shown an object encoder 151 belonging to an audio encoding apparatus, and an audio decoding apparatus 160 including an object decoder 161 and a mixer/renderer 163.

The object encoder 151 receives N object signals (N>1) and generates signals that are down-mixed on M channels (1<M<N). In the decoding apparatus 160, the object decoder 161 decodes the signals, which have been down-mixed on the M channels, into N object signals again, and the mixer/renderer 163 finally outputs L channel signals (L>1).

At this time, the M down-mix channels generated by the object encoder 151 comprise K core down-mix channels (K<M) and M-K non-core down-mix channels. The reason why the down-mix channels are constructed as described above is that the importance thereof may be changed according to an object signal. In other words, a general encoding and decoding method does not have a sufficient resolution with respect to an object signal and therefore may include the components of other object signals on a per object signal basis. Thus, if the down-mix channels are comprised of the core down-mix channels and the non-core down-mix channels as described above, the interference between object signals can be minimized.

In this case, the core down-mix channel may use a processing method different from that of the non-core down-mix channel. For example, in FIG. 4, side information input to the mixer/renderer 163 may be defined only in the core down-mix channel. In other words, the mixer/renderer 163 may be configured to control only object signals decoded from the core down-mix channel not object signals decoded from the non-core down-mix channel.

As another example, the core down-mix channel can be constructed of only a small number of object signals, and the object signals are grouped and then controlled based on one control information. For example, an additional core down-mix channel may be constructed of only vocal signals in order to construct a karaoke system. Further, an additional core down-mix channel can be constructed by grouping only signals of a drum, etc., so that the intensity of a low frequency signal, such as a drum signal, can be controlled accurately.

Meanwhile, music is generally generated by mixing several audio signals having the form of a track, etc. For example, in the case of music comprised of drum, guitar, piano, and vocal signals, each of the drum, guitar, piano, and vocal signals may become an object signal. In this case, one of total object signals, which is determined to be important specially and can be controlled by a user, or a number of object signals, which are mixed and controlled like one object signal, may be defined as a main object. Further, a mixing of object signals other than the main object of total object signals may be defined as a background object. In accordance with this definition, it can be said that a total object or a music object consists of the main object and the background object.

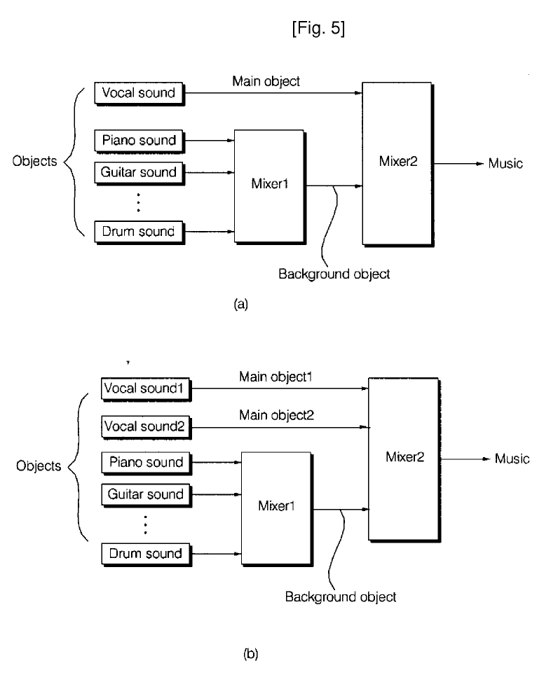

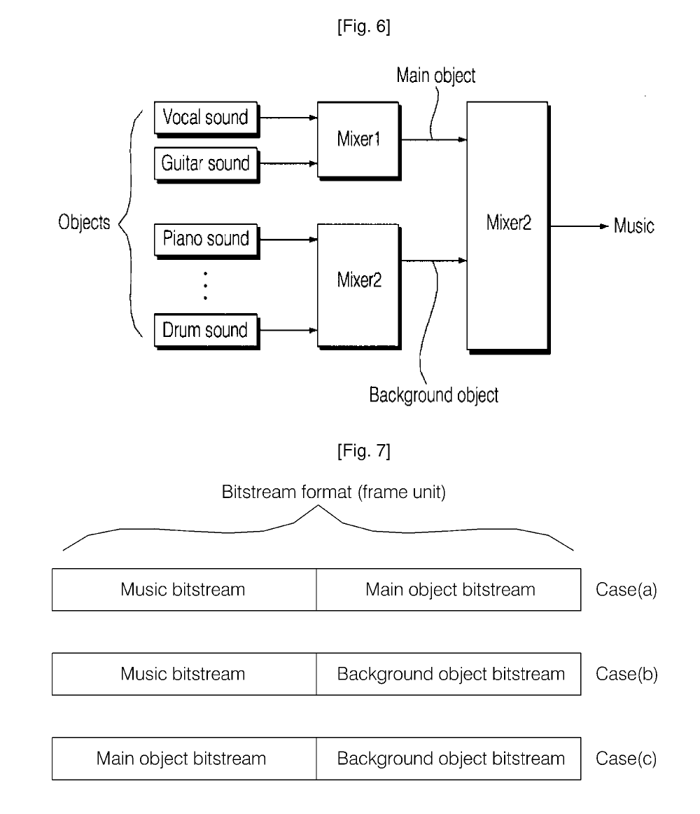

FIGS. 5 and 6 are views illustrating the main object and the background object. As shown in FIG. 5a, assuming that the main object is vocal sound and the background object is the mixing of sounds of the entire musical instruments other than the vocal sound, a music object may include a vocal object and a background object of the mixed sound of the musical instruments other than the vocal sound. The number of the main object may be one or more, as shown in FIG. 5b.

Further, the main object may have a shape in which several object signals are mixed. For example, as shown in FIG. 6, the mixing of vocal and guitar sound may be used as the main objects and the sounds of the remaining musical instruments may be used as the background objects.

In order to separately control the main object and the background object in the music object, the bitstream encoded in the encoding apparatus must have one of formats shown in FIG. 7.

FIG. 7a illustrates a case where the bitstream generated in the encoding apparatus is comprised of a music bitstream and a main object bitstream. The music bitstream has a shape in which the entire object signals are mixed, and refers to a bitstream corresponding to the sum of the entire main objects and background objects. FIG. 7b illustrates a case where the bitstream is comprised of a music bitstream and a background object bitstream. FIG. 7c illustrates a case where the bitstream is comprised of a main object bitstream and a background object bitstream.

In FIG. 7, it is made a rule to generate the music bitstream, the main object bitstream, and the background object bitstream using an encoder and a decoder having the same method. However, when the main object is used as a vocal object, the music bitstream can be decoded and encoded using MP3, and the vocal object bitstream can be decoded and encoded using a voice codec, such as AMR, QCELP, EFR, or EVRC in order to reduce the capacity of the bitstream. In other words, the encoding and decoding methods of the music object and the main object, the main object and the background object, and so on may differ.

In FIG. 7a, the music bitstream part is configured using the same method as a general encoding method. Further, in the encoding method such as MP3 or AAC, a part in which side information, such as an ancillary region or an auxiliary region, is indicated is included in the later half of the bitstream. The main object bitstream can be added to this part. Therefore, a total bitstream is comprised of a region where the music object is encoded and a main object region subsequent to the region where the music object is encoded. At this time, an indicator, flag or the like, informing that the main object is added, may be added to the first half of the side region so that whether the main object exists in the decoding apparatus can be determined.

The case of FIG. 7b basically has the same format as that of FIG. 7a. In FIG. 7b, the background object is used instead of the main object in FIG. 7a.

FIG. 7c illustrates a case where the bitstream is comprised of a main object bitstream and a background object bitstream. In this case, the music object is comprised of the sum or mixing of the main object and the background object. In a method of configuring the bitstream, the background object may be first stored and the main object may be then stored in the auxiliary region. Alternatively, the main object may be first stored and the background object may be then stored in the auxiliary region. In such a case, an indicator to inform information about the side region can be added to the first half of the side region, which is the same as described above.

FIG. 8 illustrates a method of configuring the bitstream so that what the main object has been added can be determined. A first example is one in which after a music bitstream is finished, a corresponding region is an auxiliary region until a next frame begins. In the first example, only an indicator, informing that the main object has been encoded, may be included.

A second example corresponds to an encoding method requiring an indicator, informing that an auxiliary region or a data region begins after a music bitstream is finished. To this end, in encoding a main object, two kinds of indicators, such as an indicator to inform the start the auxiliary region and an indicator to inform the main object, are required. In decoding this bitstream, the type of data is determined by reading the indicator and the bitstream is then decoded by reading a data part.

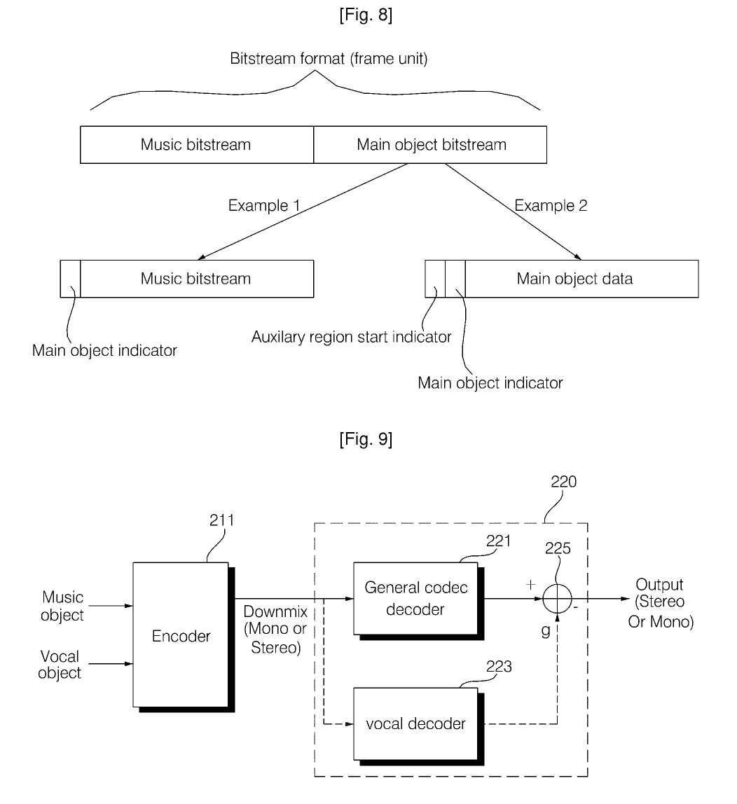

FIG. 9 is a block diagram of an audio encoding and decoding apparatus according to a fourth embodiment of the present invention. The audio encoding and decoding apparatus according to the present embodiment encodes and decodes a bitstream in which a vocal object is added as a main object.

Referring to FIG. 9, an encoder 211 included in an encoding apparatus encodes a music signal including a vocal object and a music object. Examples of the music signals of the encoder 211 may include MP3, AAC, WMA, and so on. The encoder 211 adds the vocal object to a bitstream as a main object other than the music signals.

At this time, the encoder 211 adds the vocal object to a part, informing side information such as an ancillary region or an auxiliary region, as mentioned earlier, and also adds an indicator, etc., informing the encoding apparatus of the fact that the vocal object exists additionally, to the part.

A decoding apparatus 220 includes a general codec decoder 221, a vocal decoder 223, and a mixer 225. The general codec decoder 221 decodes the music bitstream part of the received bitstream. In this case, a main object region is simply recognized as a side region or a data region, but is not used in the decoding process. The vocal decoder 223 decodes the vocal object part of the received bitstream. The mixer 225 mixes the signals decoded in the general codec decoder 221 and the vocal decoder 223 and outputs the mixing result.

When a bitstream in which a vocal object is included as a main object is received, the encoding apparatus not including the vocal decoder 223 decodes only a music bitstream and outputs the decoding results. However, even in this case, this is the same as a general audio output since the vocal signal is included in the music stream.

Further, in the decoding process, it is determined whether the vocal object has been added to the bitstream based on an indicator, etc. When it is impossible to decode the vocal object, the vocal object is disregarded through skip, etc., but when it is possible to decode the vocal object, the vocal object is decoded and used for mixing.

The general codec decoder 221 is adapted for music play and generally uses audio decoding. For example, there are MP3, AAC, HE-AAC, WMA, Ogg Vorbis, and the like. The vocal decoder 223 can use the same codec as or different from that of the general codec decoder 221. For example, the vocal decoder 223 may use a voice codec, such as EVRC, EFR, AMR or QCELP. In this case, the amount of calculation for decoding can be reduced.

Further, if the vocal object is comprised of mono, the bit rate can be reduced to the greatest extent possible. However, if the music bitstream cannot be comprised of only mono because it is comprised of stereo channels and vocal signals at left and right channels differ, the vocal object can also be comprised of stereo.

In the decoding apparatus 220 according to the present embodiment, any one of a mode in which only music is played, a mode in which only a main object is played, and a mode in which music and a main object are mixed adequately and played can be selected and played in response to a user control command such as a button or menu manipulation in a play device.

In the event that a main object is disregarded and only original music is played, it corresponds to the play of existing music. However, since mixing is possible in response to a user control command, etc., the size of the main object or a background object, etc. can be controlled. When the main object is a vocal object, it is meant that only vocal can be increased or decreased when compared with the background music.

An example in which only a main object is played can include one in which a vocal object or one special musical instrument sound is used as the main object. In other words, it is meant that only vocal is heard without background music, only musical instrument sound without background music is heard, and the like.

When music and a main object are mixed adequately and heard, it is meant that only vocal is increased or decreased when compared with background music. In particular, in the event that vocal components are completely struck out from music, the music can be used as a karaoke system since the vocal components disappear. If a vocal object is encoded in the encoding apparatus in a state where the phase of the vocal object is reversed, the decoding apparatus can play a karaoke system by adding the vocal object to a music object.

In the above process, it has been described that the music object and the main object are decoded respectively and then mixed. However, the mixing process can be performed during the decoding process. For example, in transform coding series such as MDCT (Modified Discrete Cosine Transform) including MP3 and AAC, mixing can be performed on MDCT coefficients and inverse MDCT can be performed finally, thus generating PCM outputs. In this case, a total amount of calculation can be reduced significantly. In addition, the present invention is not limited to MDCT, but includes all transforms in which coefficients are mixed in a transform domain with respect to a general transform coding series decoder and decoding is then performed.

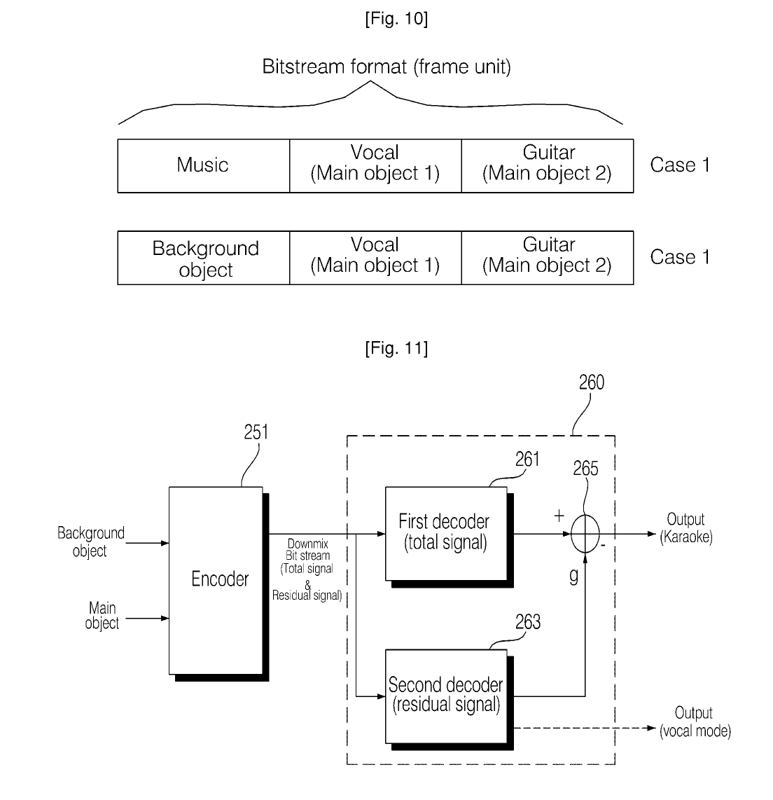

Moreover, an example in which one main object is used has been described in the above example. However, a number of main objects can be used. For example, as shown in FIG. 10, vocal can be used as a main object 1 and a guitar can be used as a main object 2. This construction is very useful when only a background object other than vocal and a guitar in music is played and a user directly performs vocal and a guitar. Further, this bitstream can be played through various combinations of music, one in which vocal is excluded from music, one in which a guitar is excluded from music, one in which vocal and a guitar vocal are excluded from music, and so on.

Meanwhile, in the present invention, a channel indicated by a vocal bitstream can be expanded. For example, the entire parts of music, a drum sound part of music, or a part in which only drum sound is excluded from the entire parts in music can be played using a drum bitstream. Further, mixing can be controlled on a per part basis using two or more additional bitstreams such as the vocal bitstream and the drum bitstream.

In addition, in the present embodiment, only stereo/mono has mainly been described. However, the present embodiment can also be expanded to a multi-channel case. For example, a bitstream can be configured by adding a vocal object, a main object bitstream, and so on to a 5.1 channel bitstream, and upon play, any one of original sound, sound from which vocal is struck out, and sound including only vocal can be played.

The present embodiment can also be configured to support only music and a mode in which vocal is struck out from music, but not to support a mode in which only vocal (a main object) is played. This method can be used when singers do not want that only vocal is played. It can be expanded to the configuration of a decoder in which an identifier, indicating whether a function to support only vocal exists or not, is placed in a bitstream and the range of play is decided based on the bitstream.

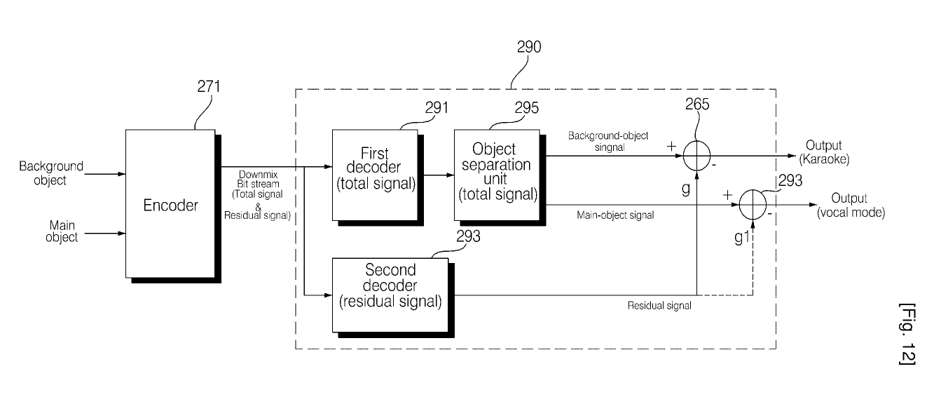

FIG. 11 is a block diagram of an audio encoding and decoding apparatus according to a fifth embodiment of the present invention. The audio encoding and decoding apparatus according to the present embodiment can implement a karaoke system using a residual signal. When specializing a karaoke system, a music object can be divided into a background object and a main object as mentioned earlier. The main object refers to an object signal that will be controlled separately from the background object. In particular, the main object may refer to a vocal object signal. The background object is the sum of the entire object signals other than the main object.

Referring to FIG. 11, an encoder 251 included in an encoding apparatus encodes a background object and a main object with them being put together. At the time of encoding, a general audio codec such as AAC or MP3 can be used. If the signal is decoded in a decoding apparatus 260, the decoded signal includes both a background object signal and a main object signal. Assuming that the decoded signal is an original decoding signal, the following method can be used in order to apply a karaoke system to the signal.

The main object is included in a total bitstream in the form of a residual signal. The main object is decoded and then subtracted from the original decoding signal. In this case, a first decoder 261 decodes the total signal and the second decoder 263 decodes the residual signal, where g=1. Alternatively, the main object signal having a reverse phase can be included in the total bitstream in the form of a residual signal. The main object signal can be decoded and then added to the original decoding signal. In this case, g=−1. In either case, a kind of a scalable karaoke system is possible by controlling the value g.

For example, when g=−0.5 or g=0.5, the main object or the vocal object is not fully removed, but only the level can be controlled. Further, if the value g is set to a positive number or a negative number, there is an effect in that the size of the vocal object can be controlled. If the original decoding signal is not used and only the residual signal is output, a solo mode where only vocal can also be supported.

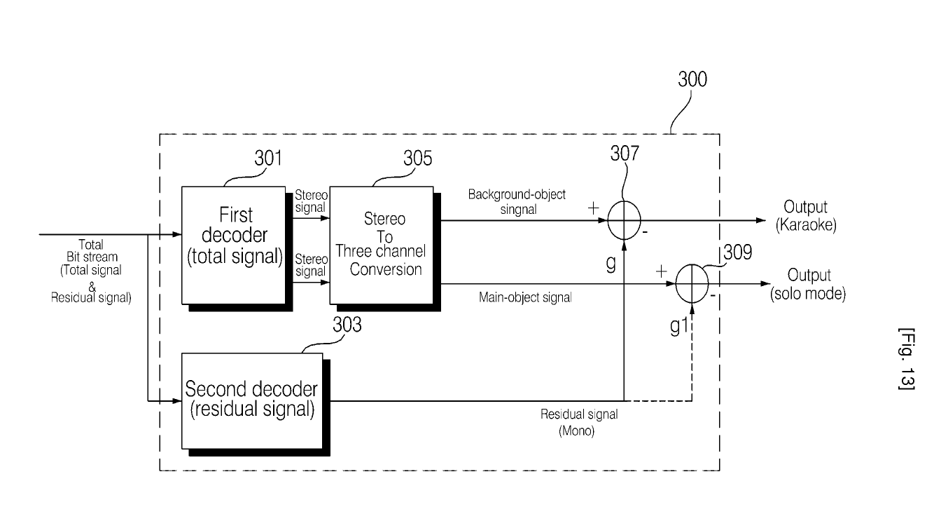

FIG. 12 is a block diagram of an audio encoding and decoding apparatus according to a sixth embodiment of the present invention. The audio encoding and decoding apparatus according to the present embodiment uses two residual signals by differentiating the residual signals for a karaoke signal output and a vocal mode output.

Referring to FIG. 12, an original decoding signal encoded in a first decoder 291 is divided into a background object signal and a main object signal and then output in an object separation unit 295. In reality, the background object includes some main object components as well as the original background object, and the main object also includes some background object components as well as the original main object. This is because the process of dividing the original decoding signal into the background object and the main object signal is not complete.

In particular, regarding the background object, the main object components included in the background object can be previously included in the total bitstream in the form of the residual signal, the total bitstream can be decoded, and the main object components can be then subtracted from the background object. In this case, in FIG. 12, g=1. Alternatively, a reverse phase can be given to the main object components included in the background object, the main object components can be included in the total bitstream in the form of a residual signal, and the total bitstream can be decoded and then added to the background object signal. In this case, in FIG. 12, g=−1. In either case, a scalable karaoke system is possible by controlling the value g as mentioned above in conjunction with the fifth embodiment.

In the same manner, a solo mode can be supported by controlling a value g1 after the residual signal is applied to the main object signal. The value g1 can be applied as described above in consideration of phase comparison of the residual signal and the original object and the degree of a vocal mode.

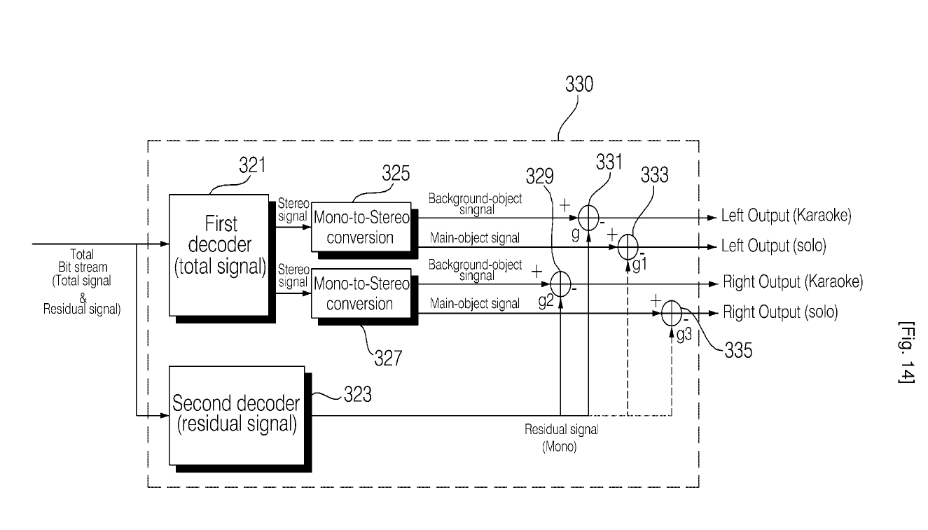

FIG. 13 is a block diagram of an audio encoding and decoding apparatus according to a seventh embodiment of the present invention. In the present embodiment, the following method is used in order to further reduce the bit rate of a residual signal in the above embodiment.

When a main object signal is mono, a stereo-to-three channel conversion unit 305 performs stereo-to-three channel transform on an original stereo signal decoded in a first decoder 301. Since the stereo-to-three channel transform is not complete, a background object (that is, one output thereof) includes some main object components as well as background object components, and a main object (that is, another output thereof) also includes some background object components as well as the main object components.

Then, a second decoder 303 performs decoding (or after decoding, qmf conversion or mdct-to-qmf conversion) on a residual part of a total bitstream and sums weighting to the background object signal and the main object signal. Accordingly, signals respectively comprised of the background object components and the main object components can be obtained.

The advantage of this method is that since the background object signal and the main object signal have been divided once through stereo-to-three channel conversion, a residual signal for removing other components included in the signal (that is, the main object components remaining within the background object signal and the background object components remaining within the main object signal) can be constructed using a less bit rate.

Referring to FIG. 13, assuming that the background object component is B and the main object component is m within the background object signal BS and the main object component is M and the background object component is b within the main object signal MS, the following formula is established.

BS=B+m

MS=M+b MathFigure 1

For example, when the residual signal R is comprised of b−m, a final karaoke output KO results in:

KO=BS+R=B+b MathFigure 2

A final solo mode output SO results in:

SO=BS−R=M+m MathFigure 3

The sign of the residual signal can be reversed in the above formula, that is, R=m−b, g=−1 & g1=1.

When configuring BS and MS, the values of g and g1 in which the final values of KO and SO will be comprised of B and b, and M and m can be calculated easily depending on how the signs of B, m, M, and/or b are set. In the above cases, both karaoke and solo signals are slightly changed from the original signals, but high-quality signal outputs that can be used actually are possible because the karaoke output does not include the solo components and the solo output also does not include the karaoke components.

Further, when two or more main objects exist, two-to-three channel conversion and an increment/decrement of the residual signal can be used step by step.

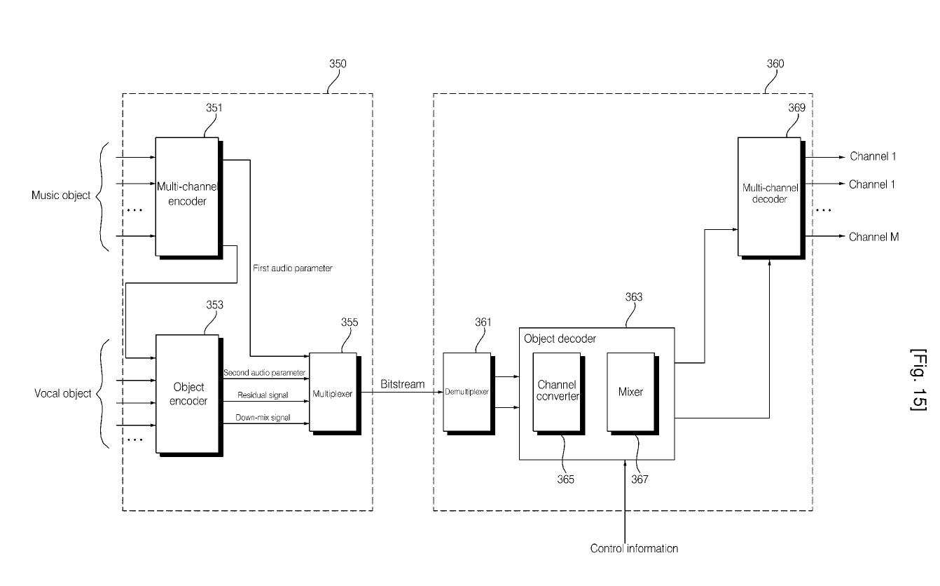

FIG. 14 is a block diagram of an audio encoding and decoding apparatus according to an eighth embodiment of the present invention. An audio signal decoding apparatus 290 according to the present embodiment is different from the seventh embodiment in that mono-to-stereo conversion is performed on each original stereo channel twice when a main object signal is a stereo signal.

Since mono-to-stereo conversion is not also perfect, a background object signal (that is, one output thereof) includes some main object components as well as background object components, and a main object signal (that is, the other output thereof) also includes some background object components as well as main object components. Thereafter, decoding (or after decoding, qmf conversion or mdct-to-qmf conversion) is performed on a residual part of a total bitstream, and left and right channel components thereof are then added to left and right channels of a background object signal and a main object signal, respectively, which are multiplied by a weight, so that signals comprised of a background object component (stereo) and a main object component (stereo) can be obtained.

In the event that stereo residual signals are formed by employing the difference between the left and right components of the stereo background object and the stereo main object, g=g2=−1, and g1=g3=1 in FIG. 14. In addition, as described above, the values of g, g1, g2, and g3 can be calculated easily according to the signs of the background object signal, the main object signal, and the residual signal. In general, a main object signal may be mono or stereo. For this reason, a flag, indicating whether the main object signal is mono or stereo, is placed within a total bitstream. When the main object signal is mono, the main object signal can be decoded using the method described in conjunction with the seventh embodiment of FIG. 13, and when the main object signal is stereo, the main object signal can be decoded using the method described in conjunction with the eighth embodiment of FIG. 14, by reading the flag.

Moreover, when one or more main objects are included, the above methods can be used consecutively depending on whether each of the main objects is mono or stereo.

At this time, the number of times in which each method is used is identical to the number of mono/stereo main objects. For example, when the number of main objects is 3, the number of mono main objects of the three main objects is 2, and the number of stereo main objects is 1, karaoke signals can be output by using the method described in conjunction with the seventh embodiment twice and the method described in conjunction with the eighth embodiment of FIG. 14 once. At this time, the sequence of the method described in conjunction with the seventh embodiment and the method described in conjunction with the eighth embodiment can be decided previously. For example, the method described in conjunction with the seventh embodiment may be always performed on mono main objects and the method described in conjunction with the eighth embodiment may be then performed on stereo main objects. As another sequence decision method, a descriptor, describing the sequence of the method described in conjunction with the seventh embodiment and the method described in conjunction with the eighth embodiment, may be placed within a total bitstream and the methods may be performed selectively based on the descriptor.

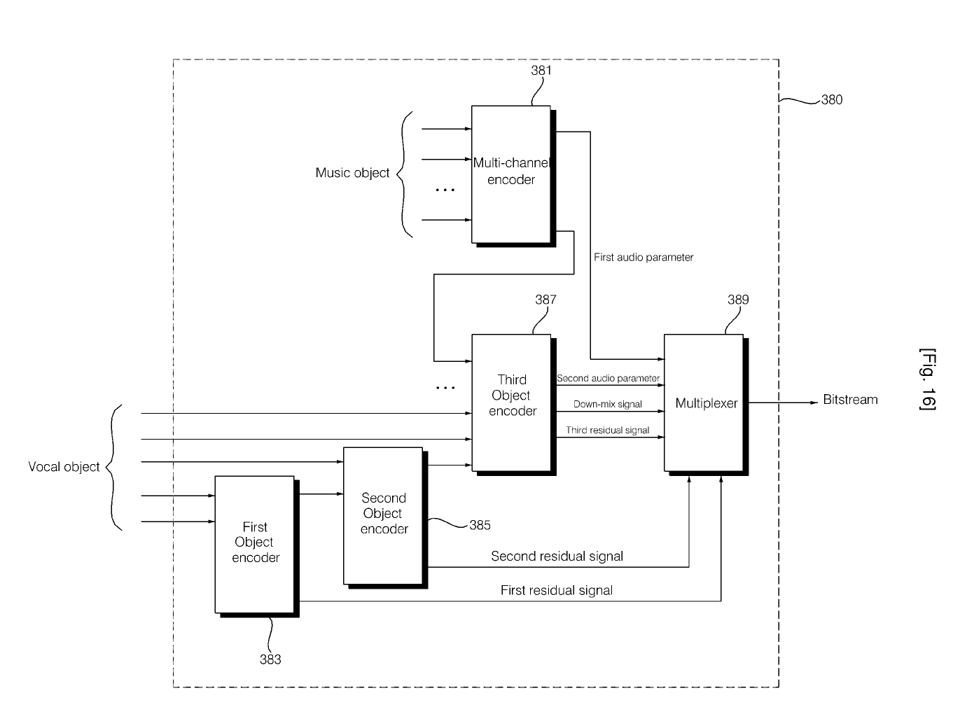

FIG. 15 is a block diagram of an audio encoding and decoding apparatus according to a ninth embodiment of the present invention. The audio encoding and decoding apparatus according to the present embodiment generates music objects or background objects using multi-channel encoders.

Referring to FIG. 15, there are shown an audio encoding apparatus 350 including a multi-channel encoder 351, an object encoder 353, and a multiplexer 355, and an audio decoding apparatus 360 including a demultiplexer 361, an object decoder 363, and a multi-channel decoder 369. The object decoder 363 may include a channel converter 365 and a mixer 367.

The multi-channel encoder 351 generates a signal, which is down-mixed using music objects as a channel basis, and channel-based first audio parameter information by extracting information about the music object. The object decoder 353 generates a down-mix signal, which is encoded using vocal objects and the down-mixed signal from the multi-channel encoder 351, as an object basis, object-based second audio parameter information, and residual signals corresponding to the vocal objects. The multiplexer 355 generates a bitstream in which the down-mix signal generated from the object encoder 353 and side information are combined. At this time, the side information is information including the first audio parameter generated from the multi-channel encoder 351, the residual signals and the second audio parameter generated from the object decoder 353, and so on.

In the audio decoding apparatus 360, the demultiplexer 361 demultiplexes the down-mix signal and the side information in the received bitstream. The object decoder 363 generates audio signals with controlled vocal components by employing at least one of an audio signal in which the music object is encoded on a channel basis and an audio signal in which the vocal object is encoded. The object decoder 363 includes the channel converter 365 and therefore can perform mono-to-stereo conversion or two-to-three conversion in the decoding process. The mixer 367 can control the level, position, etc. of a specific object signal using a mixing parameter, etc., which are included in control information. The multi-channel decoder 369 generates multi-channel signals using the audio signal and the side information decoded in the object decoder 361, and so on.

The object decoder 363 can generate an audio signal corresponding to any one of a karaoke mode in which audio signals without vocal components are generated, a solo mode in which audio signals including only vocal components are generated, and a general mode in which audio signals including vocal components are generated according to input control information.

FIG. 16 is a view illustrating case where vocal objects are encoded step by step. Referring to FIG. 16, an encoding apparatus 380 according to the present embodiment includes a multi-channel encoder 381, first to third object decoder 383, 385, and 387, and a multiplexer 389.

The multi-channel encoder 381 has the same construction and function as those of the multi-channel encoder shown in FIG. 15. The present embodiment differs from the ninth embodiment of FIG. 15 in that the first to third object encoders 383, 385, and 387 are configured to group vocal objects step by step and residual signals, which are generated in the respective grouping steps, are included in a bitstream generated by the multiplexer 389.

In the event that the bitstream generated by this process is decoded, a signal with controlled vocal components or other desired object components can be generated by applying the residual signals, which are extracted from the bitstream, to an audio signal encoded by grouping the music objects or an audio signal encoded by grouping the vocal objects step by step.

Meanwhile, in the above embodiment, a place where the sum or difference of the original decoding signal and the residual signal, or the sum or difference of the background object signal or the main object signal and the residual signal is performed is not limited to a specific domain. For example, this process may be performed in a time domain or a kind of a frequency domain such as a MDCT domain. Alternatively, this process may be performed in a subband domain such as a QMF subband domain or a hybrid subband domain. In particular, when this process is performed in the frequency domain or the subband domain, a scalable karaoke signal can be generated by controlling the number of bands excluding residual components. For example, when the number of subbands of an original decoding signal is 20, if the number of bands of a residual signal is set to 20, a perfect karaoke signal can be output. When only 10 low frequencies are covered, vocal components are excluded from only the low frequency parts, and high frequency parts remain. In the latter case, the sound quality can be lower than that of the former case, but there is an advantage in that the bit rate can be lowered.

Further, when the number of main objects is not one, several residual signals can be included in a total bitstream and the sum or difference of the residual signals can be performed several times. For example, when two main objects include vocal and a guitar and their residual signals are included in a total bitstream, a karaoke signal from which both vocal and guitar signals have been removed can be generated in such a manner that the vocal signal is first removed from the total signal and the guitar signal is then removed. In this case, a karaoke signal from which only the vocal signal has been removed and a karaoke signal from which only the guitar signal has been removed can be generated. Alternatively, only the vocal signal can be output or only the guitar signal can be output.

In addition, in order to generate the karaoke signal by removing only the vocal signal from the total signal fundamentally, the total signal and the vocal signal are respectively encoded. The following two kinds of sections are required according to the type of a codec used for encoding. First, always the same encoding codec is used in the total signal and the vocal signal. In this case, an identifier, which is able to determine the type of an encoding codec with respect to the total signal and the vocal signal, has to be built in a bitstream, and a decoder performs the process of identifying the type of a codec by determining the identifier, decoding the signals, and then removing vocal components. In this process, as mentioned above, the sum or difference is used. Information about the identifier may include information about whether a residual signal has used the same codec as that of an original decoding signal, the type of a codec used to encode a residual signal, and so on.

Further, different encoding codecs can be used for the total signal and the vocal si gnal. For example, the vocal signal (that is, the residual signal) always uses a fixed codec. In this case, an identifier for the residual signal is not necessary, and only a predetermined codec can be used to decode the total signal. However, in this case, a process of removing the residual signal from the total signal is limited to a domain where processing between the two signals is possible immediately, such as a time domain or a subband domain. For example, a domain such as mdct, processing between two signals is impossible immediately.

Moreover, according to the present invention, a karaoke signal comprised of only a background object signal can be output. A multi-channel signal can be generated by performing an additional up-mix process on the karaoke signal. For example, if MPEG surround is additionally applied to the karaoke signal generated by the present invention, a 5.1 channel karaoke signal can be generated.

Incidentally, in the above embodiments, it has been described that the number of the music object and the main object, or the background object and the main object within a frame is identical. However, the number of the music object and the main object, or the background object and the main object within a frame may differ. For example, music may exist every frame and one main object may exist every two frames. At this time, the main object can be decoded and the decoding result can be applied to two frames.

Music and the main object may have different sampling frequencies. For example, when the sampling frequency of music is 44.1 kHz and the sampling frequency of a main object is 22.05 kHz, MDCT coefficients of the main object can be calculated and mixing can be then performed only on a corresponding region of MDCT coefficients of the music. This employs the principle that vocal sound has a frequency band lower than that of musical instrument sound with respect to a karaoke system, and is advantageous in that the capacity of data can be reduced.

Furthermore, according to the present invention, codes readable by a processor can be implemented in a recording medium readable by the processor. The recording medium readable by the processor can include all kinds of recording devices in which data that can be read by the processor are stored. Examples of the recording media readable by the processor can include ROM, RAM, CD-ROM, magnetic tapes, floppy disks, optical data storages, and so on, and also include carrier waves such as transmission over an Internet. In addition, the recording media readable by the processor can be distributed in systems connected over a network, and codes readable by the processor can be stored and executed in a distributed manner.

While the present invention has been described in connection with what is presently considered to be preferred embodiments, it is to be understood that the present invention is not limited to the specific embodiments, but various modifications are possible by those having ordinary skill in the art. It is to be noted that these modifications should not be understood individually from the technical spirit and prospect of the present invention.

### INDUSTRIAL APPLICABILITY

The present invention can be used for encoding and decoding processes of objectbased audio signals, etc., process object signals with an association on a per group basis, and can provide play modes such as a karaoke mode, a solo mode, and a general mode.

1. An audio decoding method comprising:
extracting a first audio signal and a first audio parameter in which a music object are encoded on a channel basis and a second audio signal and a second audio parameter in which a vocal object are encoded on an object basis, from an audio signal;
generating a third audio signal by employing at least one of the first and second audio signals; and
generating a multi-channel audio signal by employing at least one of the first and second audio parameters and the third audio signal.

2. The audio decoding method of claim 1, wherein the first audio signal is obtained by encoding at least two music objects, and the second audio signal is obtained by encoding at least two vocal objects.

3. The audio decoding method of claim 1, wherein the third audio signal is generated based on a user control command.

4. The audio decoding method of claim 1, wherein the third audio signal is generated on the basis of addition/subtraction of a signal of at least one of the first and second audio signals.

5. The audio decoding method of claim 1, wherein the third audio signal is generated by removing at least one of the first and second audio signals.

6. The audio decoding method of claim 1, wherein the first audio signal is a signal not including a vocal component.

7. The audio decoding method of claim 1, wherein the audio signal is a signal received from a broadcasting signal.

8. An audio decoding apparatus comprising:
a multiplexer for extracting a down-mix signal and side information from a received bitstream;
an object decoder for generating a third audio signal by employing at least one of a first audio signal in which a music object extracted from the down-mix signal is encoded on a channel basis and a second audio signal in which a vocal object extracted from the down-mix signal is encoded on an object basis; and
a multi-channel decoder for generating a multi-channel audio signal by employing at least one of a first audio parameter and a second audio parameter extracted from the side information, and the third audio signal.

9. The audio decoding apparatus of claim 8, wherein the object decoder generates the third audio signal on the basis of addition/subtraction of a signal of at least one of the first and second audio signals.

10. An audio decoding method comprising the steps of:
receiving a down-mix signal;
extracting a first audio signal in which a music object including a vocal object is encoded and a second audio signal in which a vocal object is encoded, from the down-mix signal; and
generating any one of an audio signal including only the vocal object, an audio signal comprising the vocal object, and an audio signal not including the vocal object based on the first and second audio signals.

11. The audio decoding method of claim 10, wherein the first audio signal is a signal that is encoded on a channel basis, and the second audio signal is a signal that is encoded on an object basis.

12. The audio decoding method of claim 10, wherein the second audio signal is a signal of a residual form.

13. An audio decoding apparatus, comprising:
an object decoder for generating any one of an audio signal including only a vocal object, an audio signal comprising the vocal object, and an audio signal not including the vocal object based on a first audio signal in which a music object extracted from a down-mix signal is encoded and a second audio signal in which a vocal object extracted from the down-mix signal is encoded; and
a multi-channel decoder for generating a multi-channel audio signal by employing a signal output from the object decoder.

14. The audio decoding apparatus of claim 13, wherein the first audio signal is a signal that is encoded on a channel basis, and the second audio signal is a signal that is encoded on an object basis.

15. The audio decoding apparatus of claim 13, further comprising a demultiplexer for extracting the down-mix signal and side information used to generate the multi-channel audio signal from a received bitstream.

16. An audio encoding method comprising the steps of:
generating a first audio signal in which a music object is encoded on a channel basis, and a first audio parameter corresponding to the music object;
generating a second audio signal in which a vocal object is encoded on an object basis, and a second audio parameter corresponding to the vocal object; and
generating a bitstream including the first and second audio signals, and the first and second audio parameters.

17. An audio encoding apparatus comprising:
a multi-channel encoder for generating a first audio signal in which a music object is encoded on a channel basis, and a channel-based first audio parameter with respect to the music object;
an object encoder for generating a second audio signal in which a vocal object is encoded on an object basis, and an object-based second audio parameter with respect to the vocal object; and
a multiplexer for generating a bitstream including the first and second audio signals, and the first and second audio parameters.

18. A recording medium in which a program for executing a decoding method according to any one of claims 1 to 7 in a processor is recorded, the recording medium being readable by the processor.

19. A recording medium in which a program for executing an encoding method according to claim 16 in a processor is recorded, the recording medium being readable by the processor.
